(19) United States
(12) Patent Application Publication
(10) Pub. No.: US 2026/0237986 A1
(43) Pub. Date: Aug. 13, 2026

(54) CABLE CLIP ASSEMBLIES

(71) Applicant: Outdoor Wireless Networks LLC, Richardson, TX (US)

(72) Inventors: Shanguang Zhang, Suzhou (CN); Haidan Tang, Suzhou (CN); Dongmin Wang, Suzhou (CN); Rongrong Zhang, Suzhou (CN); PuLiang Tang, Suzhou (CN)

(21) Appl. No.: 19/452,604

(22) Filed: Jan. 19, 2026

Related U.S. Application Data
(60) Provisional application No. 63/757,371, filed on Feb. 12, 2025.

(51) Int. Cl. H02G 3/04; H01Q 1/24; H01Q 3/36

(52) U.S. Cl. CPC H02G 3/0456; H01Q 1/246; H01Q 3/36

(57) ABSTRACT

The present disclosure is directed to a cable clip assembly. The cable clip assembly includes a bridge member including a plurality of cable clip units extending upwardly therefrom. Each cable clip unit configured to retain a respective cable therein. The cable clip assembly further includes a pair of support members, each support member coupled to or integral with an opposing end of the bridge member and extending downwardly therefrom, and a securing mechanism coupled to a lower end of each support member. Each securing mechanism configured to secure the cable clip assembly to a mounting base or a second identical cable clip assembly in a stacked relationship.

### RELATED APPLICATION(S)

This application claims priority to and the benefit of U.S. Provisional Patent Application Ser. No. 63/757,371, filed on Feb. 12, 2025, the disclosures of which are incorporated herein by reference in full.

### FIELD

The present invention generally relates to telecommunications equipment and, more particularly, adaptive cable clip assemblies for use in base station antennas.

### BACKGROUND

Cable clips are widely used to secure coaxial cables to different assemblies within a base station antenna. For example, cable clips 40, 40′ may be used in a wiper phase shifter assembly 10, as illustrated in FIGS. 1A-1B, and/or a power divider assembly 15, as illustrated in FIG. 2. The cable clips 40, 40′ are typically applied near solder joints to help prevent stress from cables 30 shaking and causing cracks in solder joints, and thereby help improve the reliability and passive intermodulation (PIM) stability of the antenna.

As shown in FIGS. 1A-1B, the wiper phase shifter assembly 10 includes first and second phase shifters 14. The phase shifter assembly 10 further includes two (stationary) co-planar laterally spaced apart and adjacent main printed circuit boards 12 attached on a top side of a mounting base 20. The main printed circuit boards 12 can each be attached mechanically or adhesively to the mounting base 20. The main printed circuit boards 12 have a top side with a plurality of transmission lines 16. The transmission lines 216 on each of the main printed circuit boards 12 connects an input pad 31 to an output pad 32 that is not subjected to an adjustable phase shift.

A coaxial cable 30 or other RF transmission line component may be connected to input pad 31, and a respective coaxial cable 30 or other RF transmission line component may be connected to each respective output pad 32. As the wiper printed circuit boards 12 move, an electrical path length from the input pad 31 to each corresponding output pad 32 changes. These changes in path lengths result in phase shifts to the signals received at the output pads 32 connected to transmission lines 16.

As noted above, cable clips 40 can be used to provide the interface connection of the coaxial cables 30 to the main printed circuit boards 12. Example cable clip assemblies 60, 60′ are illustrated in FIGS. 3A-3C and FIG. 4. The cable clip assemblies 60, 60′ include a plurality of cable clips 65, 65′. As shown in FIGS. 3A-3C, each clip 65 has opposing flexible arm members 66 that define a longitudinally extending channel or recess 67. The channel or recess 67 is sized and configured to receive and retain a respective cable 30 (FIG. 3C). The cable retention clips 65, 65′ can hold the cables 30 in place during a soldering process and provide strain relief when a tower supporting a base station antenna that is subject to wind or other vibrations. In some instances, each clip 65, 65′ may include protrusions or ribs 68, 68′ extending into the channel or recess 67 that help grip smaller diameter cables 30 held therein.

In order to balance gain, return loss, cost, and reliability, different coaxial cables 30 will be used for different scenarios. However, different types of coaxial cables 30 have different outer diameters, and the same coaxial cables 30 may also have different outer diameters due to different outer jackets. The cable clip assemblies 60, 60′ shown in FIGS. 3A-3C and FIG. 4 have a few disadvantages. For example, the cable clip assemblies 60, 60′ may only be used for coaxial cables 30 having a small difference in outer diameter. For cables 30 having a larger (thicker) outer diameter, an interference fit holds the cable in the cable clip 65, 65 which makes installation difficult and could damage the cable jacket during installation. For cables 30 having a large difference in outer diameter, two sets of tooling are required, which is expensive. Also, the materials have a similar appearance, which could lead to confusion during installation.

As shown in FIGS. 5A-5B, as base station antennas 50 are becoming more complex and the number of cables increase, modular and stackable cable clip assemblies are used within the antenna housing to fix cables as needed. In addition, the phase shifter assemblies 10 (and power divider assemblies 15) become more numerous and require multi-layer stacking. As shown in FIG. 5B, the traditional solution is to use a metal beam 74 and a plurality of standoffs 76 coupled to the antenna reflector 72 to support the additional phase shifter assemblies 10 (see also FIGS. 8A-8C). This not only increases the cost of the base station antenna 50, but also introduces additional reliability risks, such as short circuits.

### SUMMARY

Embodiments of the present invention are directed to a cable clip assembly. The cable clip assembly includes a bridge member including a plurality of cable clip units extending upwardly therefrom. Each cable clip unit configured to retain a respective cable therein. The cable clip assembly further includes a pair of support members, each support member coupled to or integral with an opposing end of the bridge member and extending downwardly therefrom, and a securing mechanism coupled to a lower end of each support member. Each securing mechanism configured to secure the cable clip assembly to a mounting base or a second identical cable clip assembly in a stacked relationship.

Further embodiments of the present invention are directed to a cable clip assembly. The cable clip assembly includes a bridge member including a plurality of cable clip units extending upwardly therefrom and a plurality of cable support units extending downwardly therefrom. The assembly further includes a pair of support members, each support member coupled to or integral with an opposing end of the bridge member and extending downwardly therefrom, and a securing mechanism coupled to a lower end of each support member. Each securing mechanism configured to secure the cable clip assembly to a mounting base or a second identical cable clip assembly in a stacked relationship, and each cable clip unit and each cable support unit is configured to retain a respective cable within the assembly.

Further embodiments of the present invention are directed to a base station antenna. The base station antenna includes a phase shifter assembly, a first cable clip assembly, and a second cable clip assembly. The phase shifter assembly includes a mounting base having a main printed circuit board attached on a top side of the mounting base. The main printed circuit board has a top side with a plurality of transmission lines, each transmission line connecting an input pad to an output pad and a first cable is connected to the input pad and a second cable is connected to the output pad. Each cable clip assembly secured to an opposing end of the mounting base and includes a bridge member including a plurality of cable clip units extending upwardly therefrom, each cable clip unit configured to retain a respective cable therein. Each cable clip assembly further includes a pair of support members, each support member coupled to or integral with an opposing end of the bridge member and extending downwardly therefrom, and a securing mechanism coupled to a lower end of each support member, each securing mechanism configured to secure the cable clip assembly to a mounting base or a second identical cable clip assembly in a stacked relationship. The first cable is retained within a respective cable clip unit of the first cable clip assembly and the second cable is retained with a respective cable clip unit of the second cable clip assembly.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a top view of a phase shifter assembly for a base station antenna.

FIG. 1B is a side view of the phase shifter assembly shown in FIG. 1A.

FIG. 2 is a top perspective view of a power divider assembly for a base station antenna.

FIG. 3A is a side view of a prior known cable clip assembly.

FIG. 3B is a top perspective view of the cable clip assembly shown in FIG. 3A.

FIG. 3C is an enlarged side view of a cable clip of the cable clip assembly shown in FIG. 3A with a cable secured therein.

FIG. 4 is a top perspective view of another known cable clip assembly.

FIG. 5A is a partial perspective view of an example prior known base station antenna.

FIG. 5B is a cross-sectional end view of the base station antenna shown in FIG. 5A showing multiple phase shifter assemblies stacked therein.

FIG. 6A is an exploded perspective view of a cable clip assembly according to embodiments of the present invention.

FIG. 6B is an exploded side view of the cable clip assembly shown in FIG. 6A.

FIG. 6C illustrates the adaptability of the cable clips of the cable clip assembly shown in FIG. 6A according to embodiments of the present invention.

FIG. 7A is a partially exploded perspective view showing of two cable clip assemblies stacked together according to embodiments of the present invention.

FIG. 7B is a partially exploded side view of the stacked cable clip assemblies shown in FIG. 7A.

FIG. 7C is a side view showing three cable clip assemblies stacked together according to embodiments of the present invention.

FIGS. 8A-8C illustrate two of the phase shifter assemblies shown in FIGS. 1A-1B stacked together using prior known cable clip assemblies.

FIG. 8D is a top perspective view of a mounting plate for one of the phase shifter assemblies shown in FIGS. 8A-8C.

FIGS. 9A-9C illustrate two of the phase shifter assemblies shown in FIGS. 1A-1B stacked together using the cable clip assembly shown in FIGS. 6A-6B according to embodiments of the present invention.

FIG. 9D is a top perspective view of a mounting plate according to embodiments of the present invention for one of the phase shifter assemblies shown in FIG. 9A-9C.

FIG. 10A is a top perspective view of another cable clip assembly according to embodiments of the present invention.

FIG. 10B is a side view of the cable clip assembly shown in FIG. 10A.

FIG. 11A is a perspective view illustrate three of the cable clip assemblies shown in FIGS. 10A-10B stacked together and securing multiple coaxial cables therein according to embodiments of the present invention.

FIG. 11B is a side view of the stacked cable clip assemblies shown in FIG. 11A.

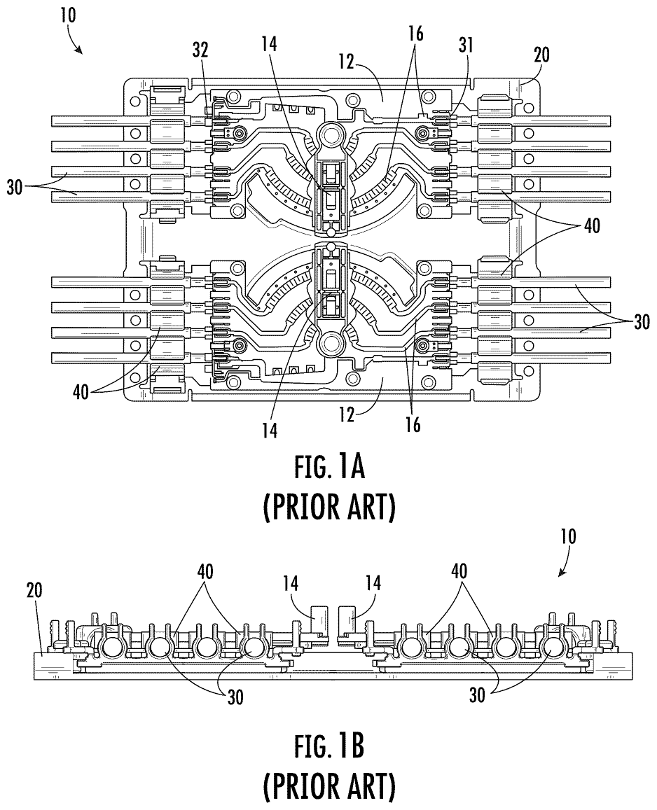

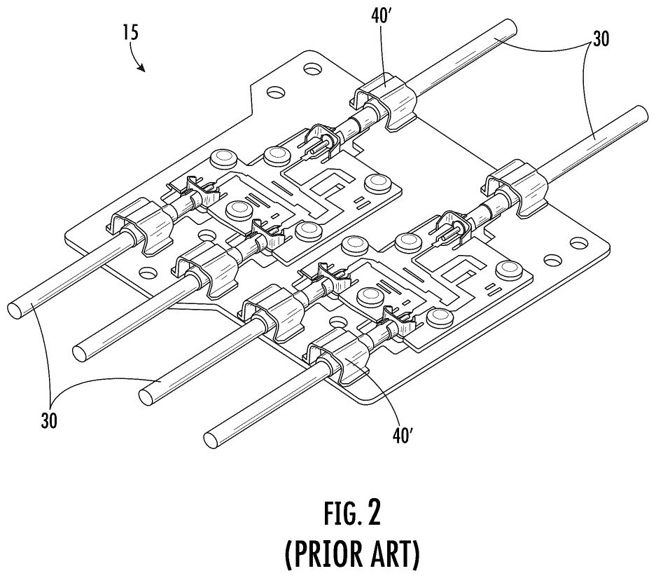

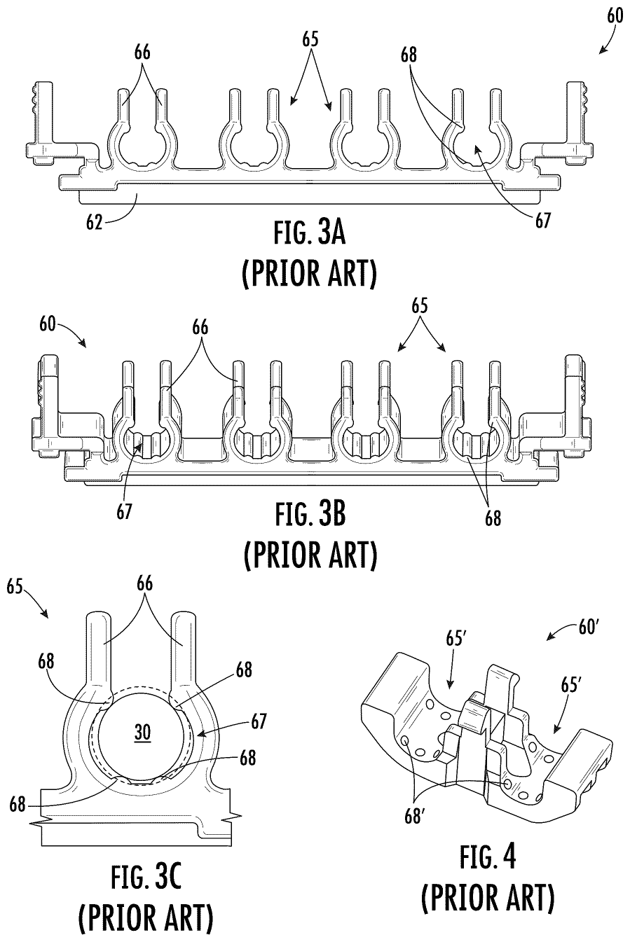

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention now will be described more fully hereinafter with reference to the accompanying drawings, in which illustrative embodiments of the invention are shown. Like numbers refer to like elements throughout and different embodiments of like elements can be designated using a different number of superscript indicator apostrophes (e.g., 10′, 10″, 10′″).

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

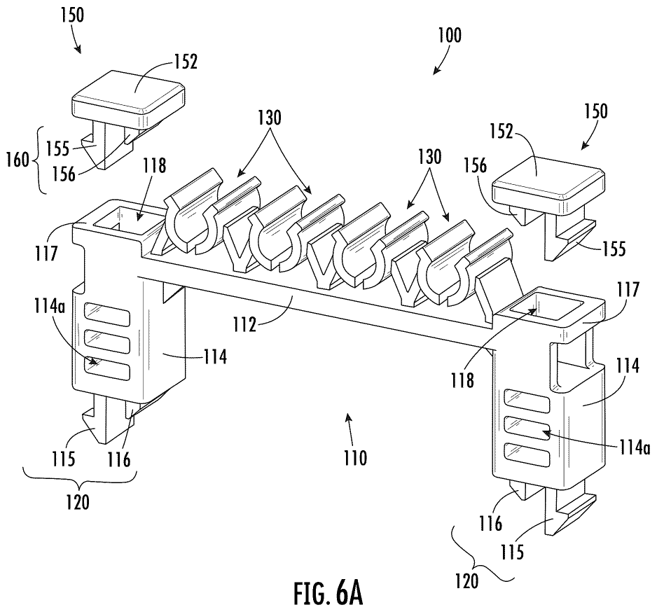

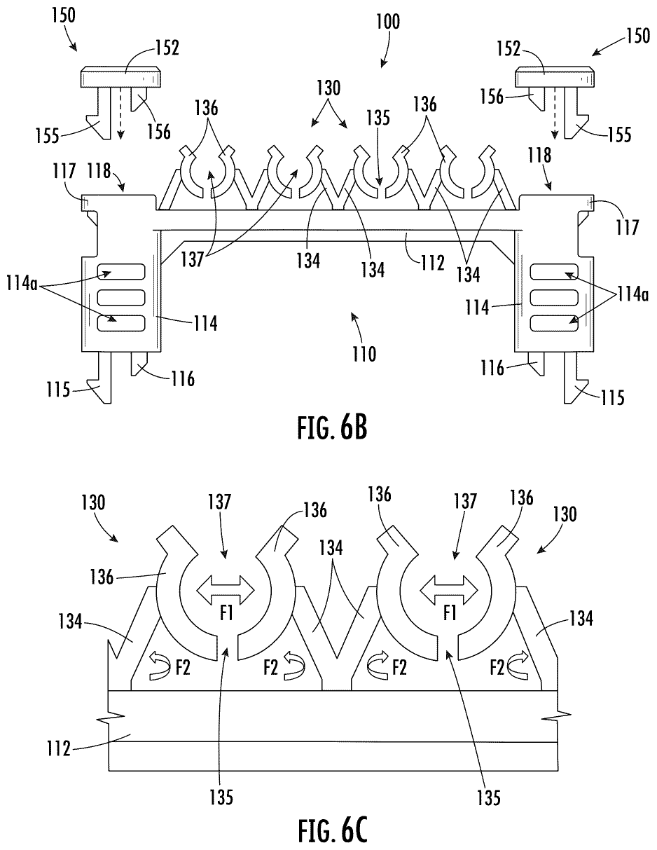

Pursuant to embodiments of the present invention, stackable adaptive cable clip assemblies are provided. According to embodiments of the present invention, the cable clip assemblies are suitable for different sizes of cables and provide for easy installation. The cable clip assemblies provide a stackable design that requires no additional auxiliary parts for installation. The modular design of the cable clip assemblies also allows for a more convenient installation process. Embodiments of the present invention will now be discussed in greater detail with reference to FIGS. 6A-11B.

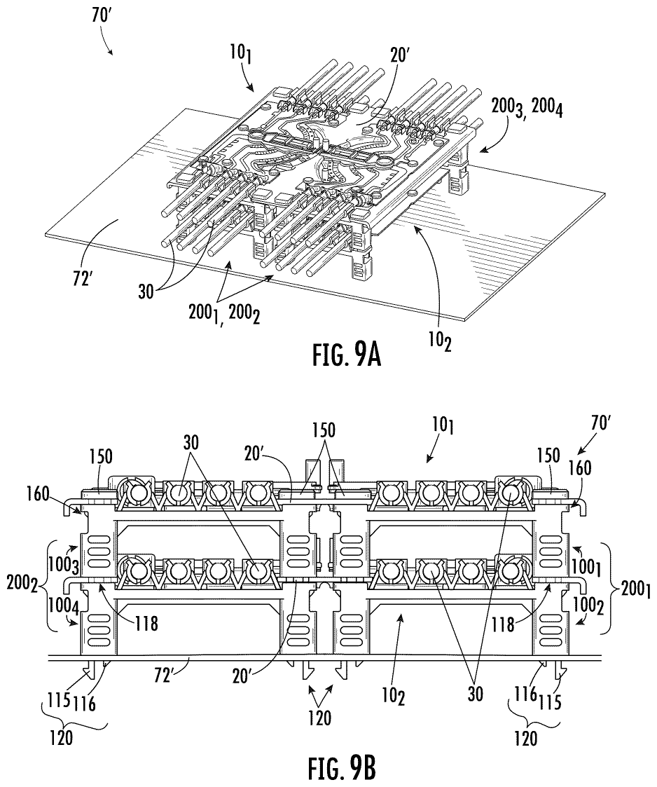

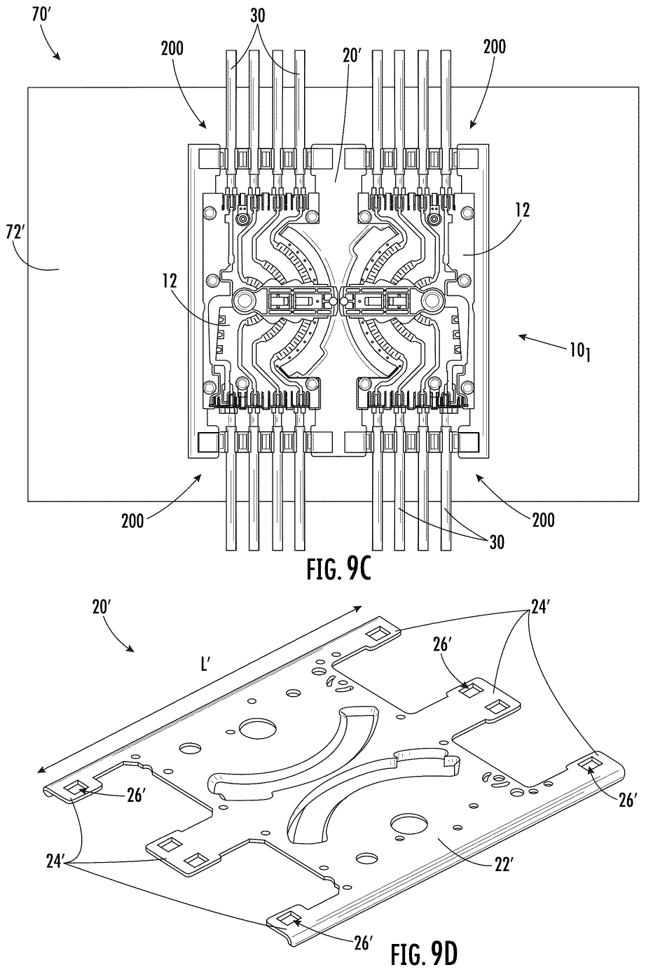

Referring to FIGS. 6A-6C, a cable clip assembly 100 according to embodiments of the present invention is illustrated. In some embodiments, the cable clip assembly 100 is formed from a polymeric material. For example, in some embodiments, the cable clip assembly 100 may comprise polycarbonate. As shown in FIGS. 6A-6B, in some embodiments, the cable clip assembly 100 comprises a bridge member 112 and a pair of support members 114. Each support member 114 is coupled to or integral with an opposing end of the bridge member 112 and extends downwardly therefrom. A plurality of cable clip units 130 is coupled to the bridge member 112 and extend upwardly therefrom. In some embodiments, the cable clip assembly 100 may comprise three or four cable clip units 130. As described in further detail below, each cable clip unit 130 is configured to receive and hold a respective cable 30 (e.g., coaxial cable) therein (see, e.g., FIG. 9B).

In some embodiments, each cable clip unit 130 comprises a pair of opposing arm members 136 that define a channel or recess 137 therebetween. Similar to the channel or recess 67 of cable clips 65, 65′ described above, the channel or recess 137 of the cable clip unit 130 is sized and configured to receive and retain a respective cable 30. In some embodiments, each arm member 136 may have an arcuate profile that corresponds with the profile of the outer jacket of the cable 30 held therebetween. In some embodiments, each arm member 136 may be coupled to the bridge member 112 via a corresponding leg member 134. As shown in FIG. 6C, in some embodiments, each arm member 136 may be configured to exert a force F1 on a cable 30 held within the channel 137. In some embodiments, each leg member 134 may be configured to further exert an additional force F2 on the corresponding arm members 136 (and corresponding cable 30 held therebetween) to help retain the cable 30 within the respective channel 137. For example, in some embodiments, the properties of the polymeric material that forms the cable clip assembly 100 provides a certain amount of flexibility which allows the arm members 136 to deflect such that a cable 30 may be inserted into the channel or recess 137 formed therebetween, and the resilient nature of the polymeric material allows the arm members 136 to engage with the cable 30 captured within the channel 137.

Thus, after a cable 30 has been received in the channel or recess 137, in some embodiments, the resilient nature of the polymeric material that forms the cable clip assembly 100 exerts a biasing force F1 against the cable 30 to help retain the cable 30 within the cable clip unit 130. In addition, the leg members 134 may further exert a biasing force F2 (e.g., compressive force) against the respective arm members 137 to further help retain the cable 30 within the cable clip unit 130. For example, as shown in FIG. 6C, in some embodiments, the leg members 134 may extend between the bridge member 112 and the corresponding arm member 136 at an angle which may push opposing arm members 137 of the respective cable clip unit 130 toward each other to further hold the cable 30 therebetween.

As shown in FIG. 6B, in some embodiments, a gap 135 may reside between a lower end of each opposing arm member 136 of each cable clip unit 130. The gap 135 between the opposing arm members 136 may provide for additional flexibility such that each cable clip unit 130 is capable of retaining larger diameter cables 30 therein.

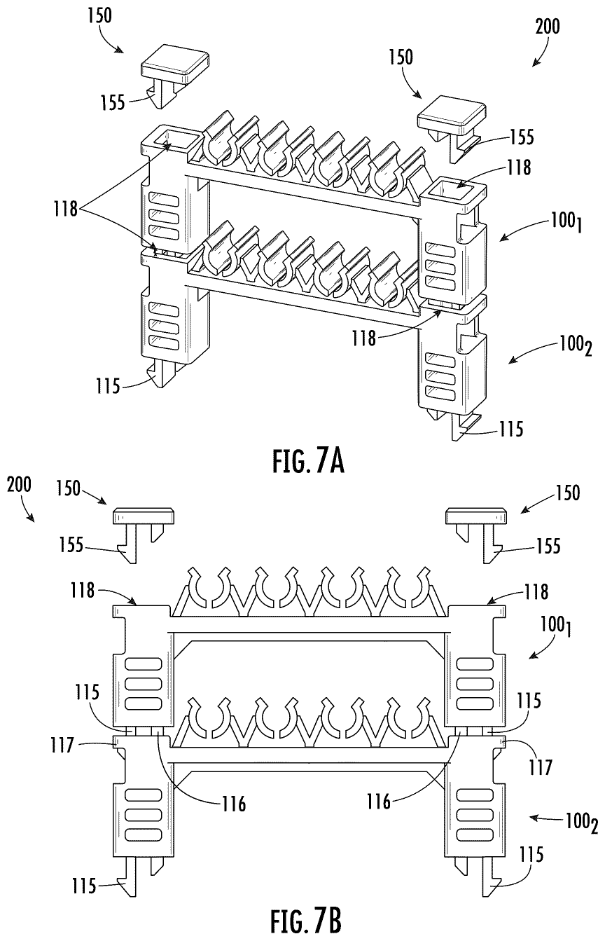

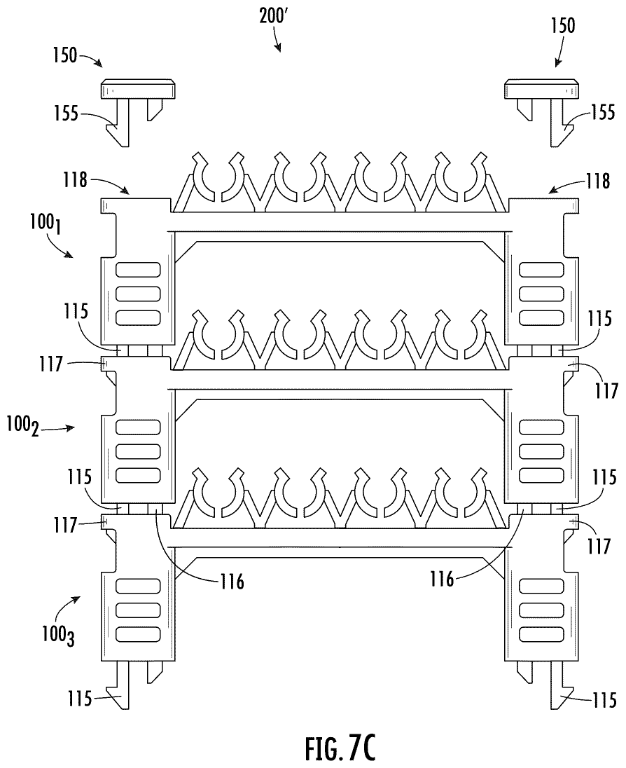

Still referring to FIGS. 6A-6B, in some embodiments, each support member 114 includes a securing mechanism 120. Each securing mechanism 120 is coupled to a lower end of the respective support member 114. As described in further detail below, in some embodiments, the securing mechanism 120 may be configured to engage an antenna reflector 72′ (see, e.g., FIG. 9B) or another cable clip assembly 100, for example, when two or more cable clip assemblies 100₁, 100₂ are stacked together (see, e.g., FIGS. 7A-7C and FIGS. 9A-9B). In some embodiments, the securing mechanism 120 may comprise a latching member 116. In some embodiments, the securing mechanism 120 may further comprise a guiding member 115. In some embodiments, the latching member 116 and guiding member 115 extending downwardly from the lower end of the respective support member 114.

As further shown in FIGS. 6A-6B, in some embodiments, an upper end of each support member 114 includes an opening 118 (i.e., residing at an opposing end of the support member 114 from the securing mechanism 120). In some embodiments, the upper end of each support member 114 may comprise a shoulder or lip 117. As described in further detail below, in some embodiments, the opening 118 and shoulder 117 are configured to engage with a corresponding securing mechanism 120 of another cable clip assembly 100, for example, when two or more cable clip assemblies 100₁, 100₂ are stacked together, thereby securing the stacked cable clip assemblies 200, 200′ together (see, e.g., FIGS. 7A-7C and FIGS. 9A-9B). In some embodiments, at least one of the support members 114 may have one or more additional apertures 114a which may help to reduce the overall weight of the cable clip assembly 100.

In some embodiments, the opening 118 and shoulder 117 in each support member 114 may be configured to engage with a respective securing mechanism 160 of a corresponding cap member 150. For example, as further shown in FIGS. 6A-6B, in some embodiments, the cable clip assembly 100 may further comprise a pair of cap members 150. Each cap member 150 has a main body 152. The securing mechanism 160 is coupled to the main body 152 and extends downwardly therefrom. Similar to the securing mechanisms 120 extending from the support members 114, in some embodiments, the securing mechanisms 160 of the cap members 150 may comprise a latching member 155 and a guiding member 156.

As shown in FIG. 6B, in some embodiments, the securing mechanisms 160 of each cap members 150 are configured to be received by the opening 118 in the upper end of a respective support member 114 of the cable clip assembly 100. In some embodiments, the guiding member 156 is configured to help to position the cap member 150 into the opening 118 as the latching member 155 is configured to engage the shoulder 117 of the corresponding support member 114. In some embodiments, the guiding member 156 also may help secure the cap member 150 within the opening 118 of the support member 114 (e.g., by creating an interference fit with an inner surface of the opening 118). In some embodiments, the cap member 150 is secured to the support member 114 through engagement of the latching member 155 with the shoulder 117. For example, in some embodiments, the latching member 155 is provided as a cantilevered snap-fit mechanism that is configured to deflect as the cap member 150 is being inserted into the opening 118 in order to engage with the shoulder 117. In some embodiments, the cap members 150 may be used to help secure a mounting base 20′ of a phase shifter assembly 10 to the cable clip assembly 100 (see, e.g., FIGS. 9A-9C).

Referring now to FIGS. 7A-7C, as mentioned herein, in some embodiments, multiple cable clip assemblies 100₁, 100₂, 100₃ may configured to be stacked together in a stacked phase shifter assembly 200, 200′ (see also FIGS. 9A-9C). For example, in some embodiments, two cable clip assemblies 100₁, 100₂ may be stacked together to form a stacked phase shifter assembly 200 (FIGS. 7A-7B). In other embodiments, three cable clip assemblies 100₁, 100₂, 100₃ may be stacked together to form a stacked assembly 200′ (FIG. 7C). While not illustrated in the figures, it is understood that more than three cable clip assemblies 100 may be stacked together, if needed. Similar to the securing mechanisms 160 of the cap members 150 described herein, the securing mechanisms 120 that extend from the lower end of each support member 114 of one cable clip assembly 100₁ may be received by the openings 118 in the upper ends of the corresponding support members 114 of a second cable clip assembly 100₂ to stack the two cable clip assemblies 100₁, 100₂ together, for example, as shown in FIGS. 7A-7B. This may be repeated when three or more cable clip assemblies 100₁, 100₂, 100₃ are stacked together in a stacked phase shifter assembly 200′, for example, as shown in FIG. 7C.

In some embodiments, the securing mechanisms 120 extending from the support members 114 may also function in a similar manner as the securing mechanisms 160 of the cap members 150. For example, in some embodiments, when securing two cable clip assemblies 100₁, 100₂ together in a stacked relationship (i.e., stacked assembly 200), the guiding member 116 of the first cable clip assembly 100₁ may be configured to help position the corresponding securing mechanism 120 into the opening 118 of the second cable clip assembly 100₂ as the latching member 115 of the first cable clip assembly 100₁ moves into engagement with the shoulder 117 of the second cable clip assembly 100₂. In some embodiments, the latching member 115 is provided as a cantilevered snap-fit mechanism that is configured to deflect when being inserted into the opening 118 and return to its original position to engage with the shoulder 117 of the second cable clip assembly 100₂, thereby securing the two cable clip assemblies 100₁, 100₂ together. In some embodiments, the guiding member 116 also may help secure the cable clip assembly 100₁ within the opening 118 of the second cable clip assembly 100₂ (e.g., by creating an interference fit with an inner surface of the opening 118).

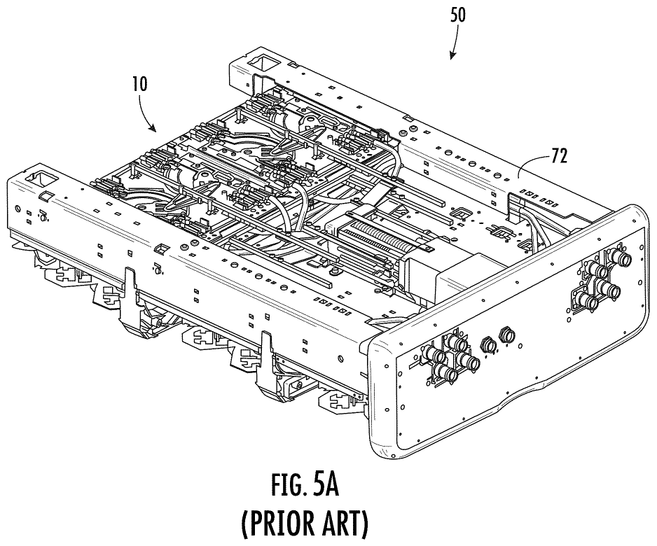

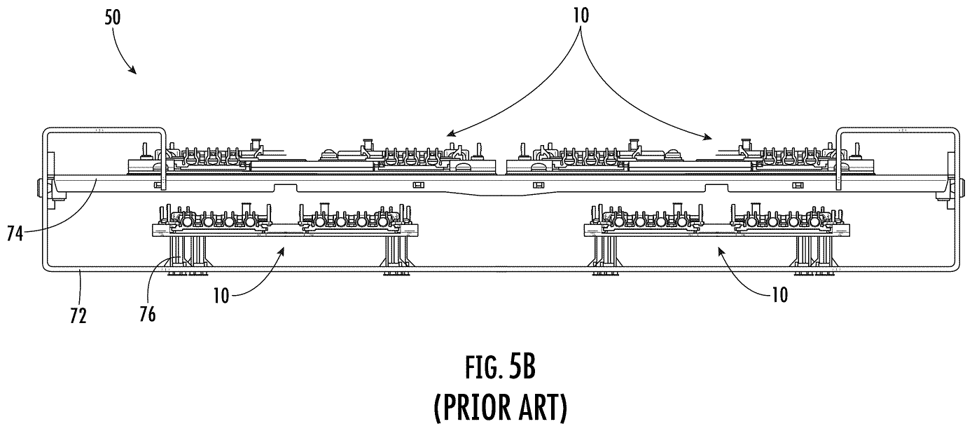

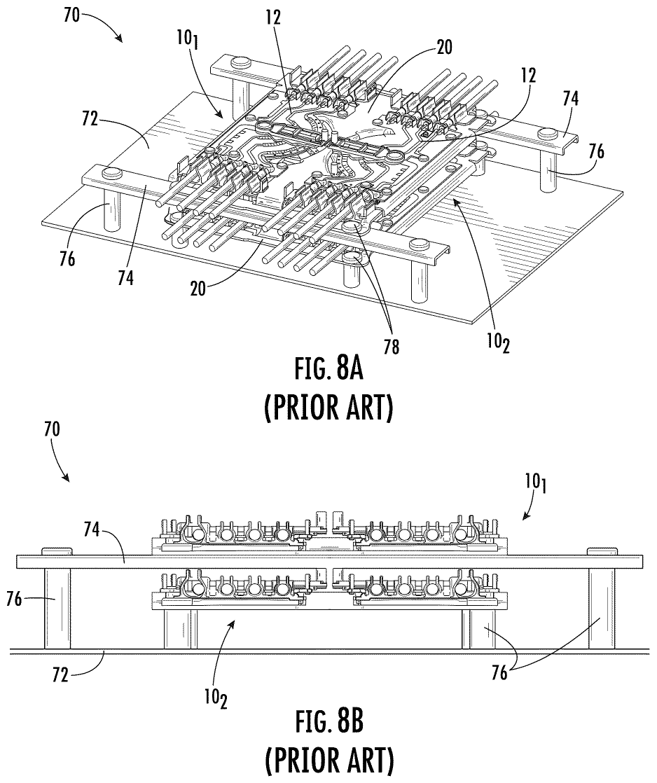

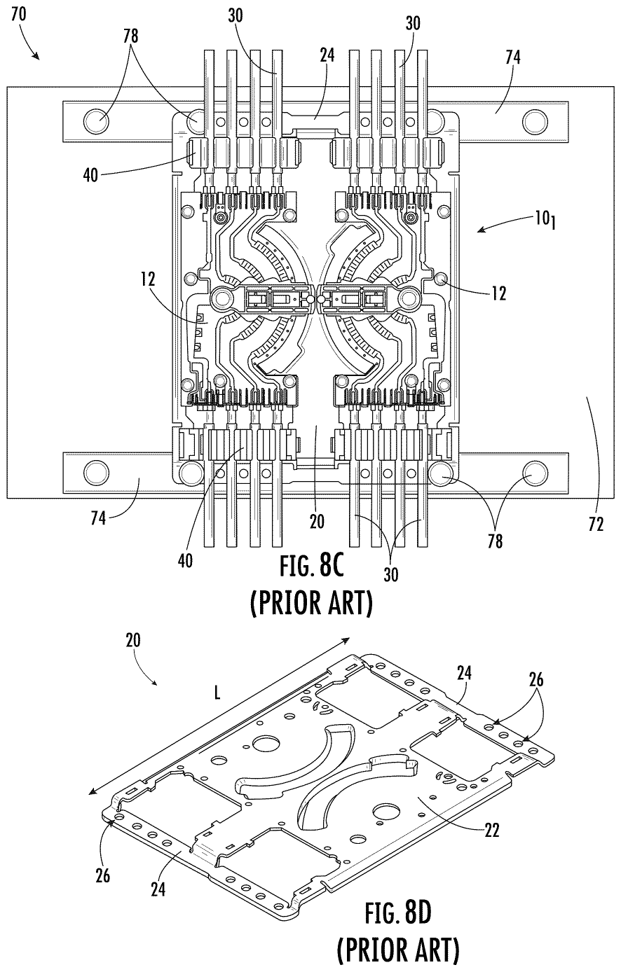

Referring to FIGS. 8A-8D, in general, when multiple phase shifter assemblies 10₁, 10₂ are stacked within a base station antenna 50, a plurality of standoffs 76 and metal beams 74 are used to connect the mounting bases 20 to the antenna reflector 72 (see also FIGS. 5A-5B). The soldering of the main printed circuit boards 12 to the mounting base 20, and the mounting base 20 being coupled to the antenna reflector 72 by the standoffs 76 (e.g., via fasteners 78), together provides an electrical ground for the stacked phase shifter assembly 70. Typically, the mounting base 20 and standoffs 206 comprise aluminum, stainless steel, other metals or metal alloys. However, as discussed above, the metal-to-metal contact between the mounting base 20 and the standoffs 76 (and antenna reflector 72) can be a source of unwanted PIM within the base station antenna 50.

An example mounting base 20 that may be used in the phase shifter assemblies 10₁, 10₂ is illustrated in FIG. 8D. The mounting base 20 has a main section 22 on which the main printed circuit boards 12 and cable clips 40 are attached (see, e.g., FIG. 8C). Mounting plates 24 are coupled to opposing ends of the main section 22. The mounting plates 24 comprise a plurality of apertures 26 which provide locations for the standoffs 76 to be secured to the mounting base 20 such that the mounting base 20 may be connected to the antenna reflector 72. As shown in FIG. 8D, the mounting base 20 has a length L defined by the main section 22 and the mounting plates 24.

Referring now to FIGS. 9A-9C, a stacked phase shifter assembly 70′ according to embodiments of the present invention is illustrated. While FIGS. 9A-9C show two phase shifter assemblies 10₁, 10₂ stacked together, as described herein, in some embodiments, more than two phase shifter assemblies 10₁, 10₂ may be stacked, if needed. According to embodiments of the present invention, as shown in FIGS. 9A-9C, in the stacked phase shifter assembly 70′, the plurality of standoffs 76, metal beams 74, and cable clips 40 of the stacked phase shifter assembly 70 (see FIGS. 8A-8C) have been replaced with a plurality of cable clip assemblies 100 of the present invention (i.e., stacked cable clip assemblies 200₁, 200₂, 200₃, 200₄). The stacked cable clip assemblies 200 are configured to connect the mounting bases 20′ of the phase shifter assemblies 10₁, 10₂ to the antenna reflector 72′ while positioning the phase shifter assemblies 10₁, 10₂ in a stacked relationship within a base station antenna 50 (i.e., stacked phase shifter assembly 70′). The stacked phase shifter assembly 70′ provides a number of advantages over the currently used stacked phase shifter assembly 70 shown in FIGS. 8A-8C, including, but not limited to, having a smaller size, utilizing fewer parts, having a lower cost, and offering better compatibility.

FIG. 9D illustrates an example mounting base 20′ that may be used in the phase shifter assemblies 10₁, 10₂ in order to accommodate installation of the cable clip assembly 100 of the present invention in a base station antenna 50. Similar to the currently used mounting base 20 described above, the mounting base 20′ according to embodiments of the present invention, has a main section 22′ on which the main printed circuit boards 12 of a phase shifter assembly 10 are attached. The mounting base 20′ of the present invention differs from the mounting base 20 in that the mounting base 20′ no longer has cable clips 40 or mounting plates 24 are coupled to opposing ends of the main section 22′. Instead, the mounting base 20′ has spaced apart mounting sections 24′ extending from opposing ends of the main section 22′ Each mounting section 24′ includes at least one aperture 26′ which provide locations to engage or receive the securing mechanisms 120, 160 of the support members 114 or cap members 150 of the cable clip assembly 100 of the present invention (see, e.g., FIG. 9B). As shown in FIG. 8D, the main section 22′ and mounting sections 24′ together define a length L′ of the mounting base 20′. In some embodiments, the length L′ of the mounting base 20′ is less than the length L of the currently used mounting base 20 (i.e., has a smaller size).

Referring back to FIG. 9B, a side view of the stacked phase shifter assembly 70′ is illustrated. As shown in FIG. 9B, in some embodiments, when two phase shifter assemblies 10₁, 10₂ are stacked, four cable clip assemblies 100₁₋₄ of the present invention may be used on opposing sides of the assembly 70′ (for a total of eight cable clip assemblies 100). On each side of the assembly 70′, two cable clip assemblies 100₂, 100₄ are used to secure the lower phase shifter assembly 10₂ to the antenna reflector 72′ for example, via the securing mechanisms 120 (i.e., guiding members 116 and latching members 115). As shown in FIG. 9B, the securing mechanisms 120 of the upper cable clip assemblies 100₁, 100₃ are received through aligned apertures 26′ in the mounting base 20′ (see also FIG. 9D) of the lower phase shifter assembly 10₂ and into corresponding openings 118 in the lower cable clip assemblies 100₂, 100₄, thereby securing the lower phase shifter assembly 10₂ between the stacked cable clip assemblies 200₁, 200₂. The securing mechanisms 160 of the cap members 150 are received through apertures 26′ in the mounting base 20′ of the upper phase shifter assembly 10₁ and into corresponding openings 118 in the upper cable clip assemblies 100₁, 100₃, thereby securing the upper phase shifter assembly 10₁ to the stacked cable clip assemblies 200₁, 200₂. Accordingly, in some embodiments, the lower phase shifter assembly 10₂ may be secured between stacked cable clip assemblies 200₁, 200₂ and the upper phase shifter assembly 10₁ may be secured with cap members 150. According to embodiments of the present invention, the stacked cable clip assemblies 200₁, 200₂ provide strain relief to the cables 30 attached to and extending from the phase shifter assemblies 10₁, 10_{2,} thereby helping to improve the reliability and PIM stability of the base station antenna 50.

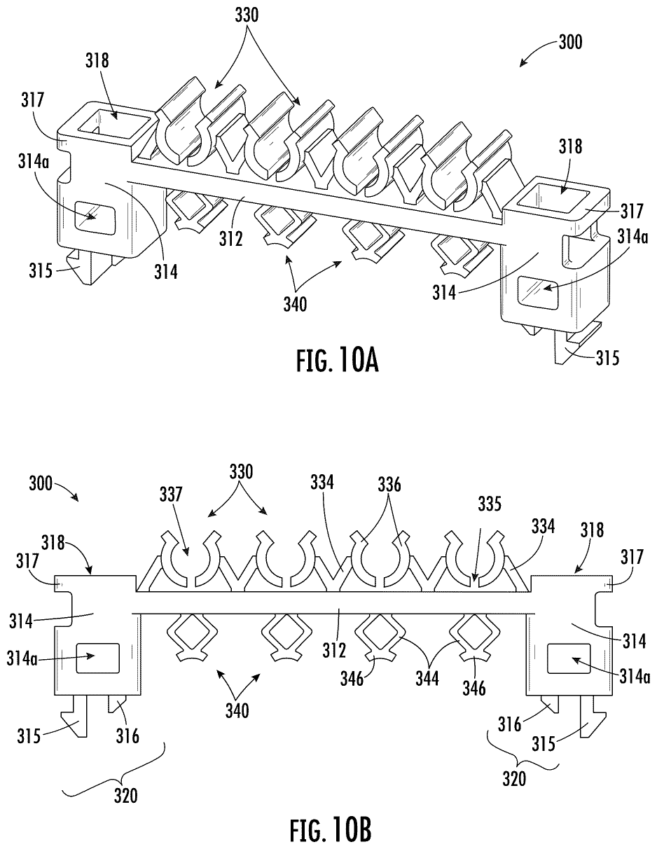

Referring now to FIGS. 10A-10B, an alternative cable clip assembly 300 according to embodiments of the present invention is illustrated. Properties and/or features of the cable clip assembly 300 may be as described above in reference to the cable clip assembly 100 shown in FIGS. 6A-6C and duplicate discussion thereof may be omitted herein for the purposes of discussing FIGS. 10A-10B.

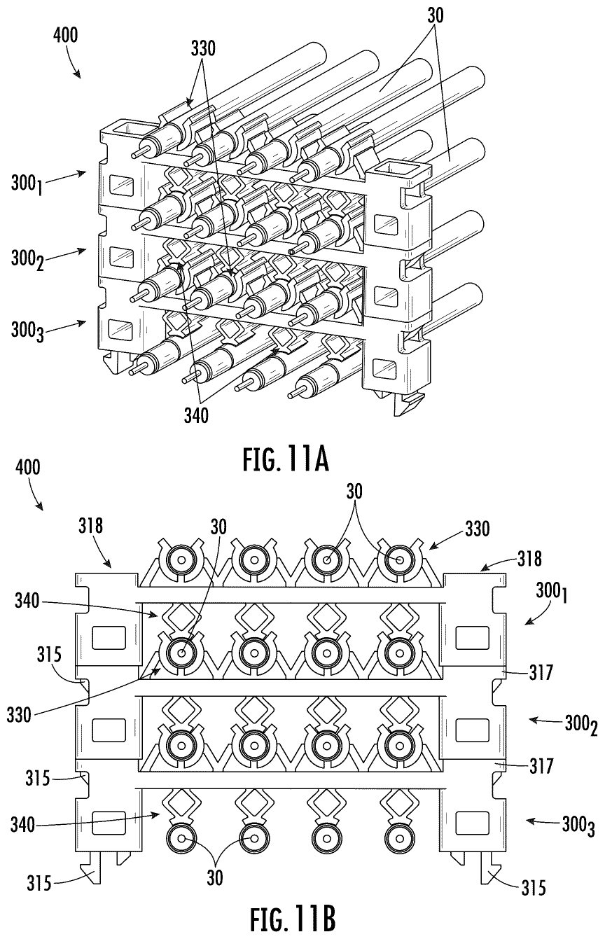

In some embodiments, the cable clip assembly 300 is formed from a polymeric material. As shown in FIGS. 10A-10B, in some embodiments, the cable clip assembly 300 comprises a bridge member 312 and a pair of support members 314. Each support member 314 is coupled to or integral with an opposing end of the bridge member 312 and extends downwardly therefrom. A plurality of cable clip units 330 is coupled to an upper surface of the bridge member 312 and extend upwardly therefrom. In some embodiments, the cable clip assembly 300 may comprise three or four cable clip units 330. As described in further detail below, each cable clip unit 330 is configured to receive and hold a respective coaxial cable 30 therein (see, e.g., FIGS. 11A-11B).

In some embodiments, each cable clip unit 330 comprises a pair of opposing arm members 336 that define a channel or recess 337. The channel or recess 137 of the cable clip unit 330 is sized and configured to receive and retain a respective cable 30 (as shown in FIGS. 11A-11B). In some embodiments, each arm member 336 may have an arcuate profile that corresponds with the profile of the outer jacket of the cable 30 held therebetween. Each arm member 336 is coupled to the bridge member 312 via a corresponding leg member 334. Similar to the cable clip assembly 100, the properties of the polymeric material that forms the cable clip assembly 300 provides a certain amount of flexibility which allows the arm members 336 to deflect such that a cable 30 may be inserted into the channel 337 formed therebetween. In some embodiments, the arm and leg members 336, 334 of each cable clip unit 330 function in a similar manner as the arm and leg members 136, 134 for the cable clip units 130 described herein. For example, in some embodiments, each arm member 336 may be configured to exert a biasing force F1 on a cable 30 held within the channel 337 and each leg member 334 is configured to further exert a biasing force F2 on the corresponding arm members 336 to help retain the cable 30 within the channel 337.

After a cable 30 has been received in the channel 337 of the cable clip unit 330, in some embodiments, the resilient nature of the polymeric material that forms the cable clip assembly 300 exerts a force F1 against the cable 30 to help retain the cable 30 within the cable clip unit 330. In addition, the leg members 334 may further exert a force F2 (e.g., compress) against the respective arm members 337 to also help retain the cable 30 within the cable clip unit 330. For example, as shown in FIG. 10B, in some embodiments, the leg members 334 may extend between the bridge member 312 and the corresponding arm member 336 at an angle which may push the opposing arm members 337 of the respective cable clip unit 330 toward each other to further hold the cable 30 therebetween. As further shown in FIG. 10B, in some embodiments, a gap 335 may reside between a lower end of each opposing arm member 336 of each cable clip unit 330 which may provide for additional flexibility such that the cable clip unit 330 is capable of retaining larger diameter cables 30 therein.

In some embodiments, the cable clip assembly 300 may further comprise a plurality of cable support units 340 coupled to a lower surface of the bridge member 312 and extend downwardly therefrom. In some embodiments, the cable clip assembly 300 may comprise three or four cable support units 340. In some embodiments, the cable clip assembly 300 comprises an equal number of cable clip units 330 and cable support units 340. As described in further detail below, similar to the cable clip units 330, each cable support unit 340 configured to engage and secure a respective cable 30 (e.g., a coaxial cable) within the cable clip assembly 300 (see, e.g., FIGS. 11A-11B).

As shown in FIG. 10A-10B, each cable support unit 340 comprises opposing leg members 344 coupled to a cable recess member 346. An end of each leg member 344 is coupled to the lower surface of the bridge member 312 and the opposing ends of each leg member 344 may be coupled to the cable recess member 346. In some embodiments, the cable recess member 346 may be concave and configured to receive at least a portion of a cable 30 (see, e.g., FIGS. 11A-11B). In some embodiments, each cable support unit 340 may be configured to exert a biasing force against a respective cable 30 to secure the cable 30 within the cable clip assembly 300. In some embodiments, the leg members 344 of each cable support unit 340 may be configured to slightly compress when a cable 30 is received by the cable recess member 346, thereby allowing different sized cables 30 to be secured within the cable clip assembly 300. For example, as shown in FIG. 10B (see also FIG. 11B), in some embodiments, the leg members 344 may together form a diamond shape which may help the cable support unit 340 compress or deflect (e.g., when engaged with a cable 30).

Still referring to FIGS. 10A-10B, similar to the cable clip assembly 100 described herein, in some embodiments, each support member 314 of the cable clip assembly 300 includes a securing mechanism 320. Each securing mechanism 320 is coupled to a lower end of the respective support member 314. In some embodiments, the securing mechanisms 320 may be configured to engage an antenna reflector 72′ (similar to the cable clip assembly 100) or may be configured to engage with another cable clip assembly 300, for example, when stacked together (FIGS. 11A-11B). In some embodiments, each securing mechanism 320 may comprise a latching member 316. In some embodiments, each securing mechanism 320 may further comprise a guiding member 315. In some embodiments, the latching member 316 and guiding member 315 extending downwardly from the lower end of the corresponding support member 314.

As shown in FIGS. 10A-10B, in some embodiments, an upper end of each support member 314 further includes an opening 318 (i.e., an opposing end from the securing mechanism 320). In some embodiments, the upper end of each support member 314 may comprise a shoulder or lip 317. In some embodiments, the opening 318 and shoulder 317 are configured to engage with a corresponding securing mechanism 320 of another cable clip assembly 300, for example, when two or more cable clip assemblies 300₁, 300₂ are stacked together (see, e.g., FIGS. 11A-11B). In some embodiments, the support members 314 may have one or more additional apertures 314a with help to reduce the overall weight of the cable clip assembly 300. While not shown, in some embodiments, the openings 318 and shoulder 317 may also be configured to engage with a corresponding securing mechanism from a cap member, such as the securing mechanism 160 of cap member 150 described herein.

Referring now to FIGS. 11A-11B, as mentioned herein, in some embodiments, multiple cable clip assemblies 300₁, 300₂, 300₃ may configured to be stacked together in a stacked phase shifter assembly 400. Properties and/or features of the stacked phase shifter assembly 400 may be as described above in reference to the stacked phase shifter assemblies 200, 200′ shown in FIGS. 7A-7C and duplicate discussion thereof may be omitted herein for the purposes of discussing FIGS. 11A-11B.

As shown in FIGS. 11A-11B, similar to the stacked phase shifter assemblies 200, 200′ described herein, the securing mechanisms 320 that extend from the lower end of each support member 314 of one cable clip assembly 300₁ may be received by the openings 318 in the upper ends of the corresponding support members 314 of a second cable clip assembly 300₂ to stack the two (or more) cable clip assemblies 300₁, 300₂ together. It is noted that while three cable clip assemblies 300₁, 300₂, 300₃ are shown stacked together in FIGS. 11A-11B, in some embodiments, two or more cable clip assemblies 300 may be stacked together.

FIG. 11B illustrates the engagement of the cable clip units 330 and cable support units 340 with respective cables 30 to secure the cables 30 within the cable clip assembly assemblies 300₁, 300₂, 300₃. As shown in FIG. 11B, in some instances, a cable 30 may be retained (secured) by both a cable clip unit 330 (extending from a cable clip assembly 300 residing below the cable 30) and a cable support unit 340 (extending from a cable clip assembly 300 residing above the cable 30), whereas, in other instances, a cable 30 may be retained (secured) by only a cable clip unit 330 or a cable support unit 340.

For example, as shown in FIG. 11B, in some embodiments, each of the cables 30 residing in the upper row may only be secured by respective cable clip units 330 of the upper cable clip assembly 300₁ and each of the cables 30 residing in the lower row may only be secured by respective cable support units 340 of the lower cable clip assembly 300₃. However, in some embodiments, each of the cables 30 residing between the upper row and lower row of cables 30 (i.e., residing in the two middle rows) may be secured by both a respective cable clip unit 330 extending upwardly from one of the cable clip assemblies 300₂, 300₃ and a respective cable support unit 340 extending downwardly from one of the cable clip assemblies 300₁, 300₂.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A cable clip assembly, the cable clip assembly comprising:
a bridge member comprising a plurality of cable clip units extending upwardly therefrom, each cable clip unit configured to retain a respective cable therein;
a pair of support members, each support member coupled to or integral with an opposing end of the bridge member and extending downwardly therefrom; and
a securing mechanism coupled to a lower end of each support member, each securing mechanism configured to secure the cable clip assembly to a mounting base or a second identical cable clip assembly in a stacked relationship.

2. The cable clip assembly according to claim 1, wherein, each cable clip unit comprises a pair of opposing arm members that define a channel therebetween, the channel sized and configured to receive and retain a respective cable, each arm member coupled to the bridge member via a corresponding leg member.

3. The cable clip assembly according to claim 2, wherein each arm member is configured to exert a first biasing force on a respective cable held within the channel, and each leg member is configured to exert a second biasing force on the corresponding arm members to help retain the respective cable within the channel.

4. The cable clip assembly according to claim 2, wherein the arm members of each cable clip unit have an arcuate profile that corresponds with an outer jacket of the respective cable held therebetween.

5. The cable clip assembly according to claim 2, wherein a gap resides between a lower end of each opposing arm member of each cable clip unit, whereby the gap provides flexibility such that each cable clip unit is capable of retaining larger diameter cables therein.

6. The cable clip assembly according to claim 2, wherein each leg member may extend between the bridge member and the corresponding arm member at an angle.

7. (canceled)

8. The cable clip assembly according to claim 1, wherein each securing mechanism comprises a latching member extending downwardly from the lower end of the respective support member.

9. The cable clip assembly according to claim 8, wherein each securing mechanism further comprising a guiding member extending downwardly from the lower end of the respective support member.

10. The cable clip assembly according to claim 1, wherein an upper end of each support member comprises an opening, the openings configured to receive a respective securing mechanism of the second identical cable clip assembly.

11. The cable clip assembly according to claim 8, wherein an upper end of each support member further comprises a shoulder configured to engage with the latching member of a respective securing mechanism of the second identical cable clip assembly.

12.-14. (canceled)

15. A cable clip assembly, the cable clip assembly comprising:
a bridge member comprising a plurality of cable clip units extending upwardly therefrom and a plurality of cable support units extending downwardly therefrom,
a pair of support members, each support member coupled to or integral with an opposing end of the bridge member and extending downwardly therefrom; and
a securing mechanism coupled to a lower end of each support member, each securing mechanism configured to secure the cable clip assembly to a mounting base or a second identical cable clip assembly in a stacked relationship,
wherein each cable clip unit and each cable support unit is configured to retain a respective cable within the assembly.

16. The cable clip assembly according to claim 15, wherein, each cable clip unit comprises a pair of opposing arm members that define a channel therebetween, the channel sized and configured to receive and retain a respective cable, each arm member coupled to the bridge member via a corresponding leg member.

17. The cable clip assembly according to claim 16, wherein each arm member is configured to exert a first biasing force on a respective cable held within the channel, and each leg member is configured to exert a second biasing force on the corresponding arm members to help retain the respective cable within the channel.

18. The cable clip assembly according to claim 16, wherein a gap resides between a lower end of each opposing arm member of each cable clip unit, whereby the gap provides flexibility such that each cable clip unit is capable of retaining larger diameter cables therein.

19. The cable clip assembly according to claim 16, wherein each leg member may extend between the bridge member and the corresponding arm member at an angle.

20. The cable clip assembly according to claim 15, wherein each cable support unit comprises opposing leg members coupled to a cable recess member, the cable recess member configured to receive at least a portion of the respective cable, each cable support unit configured to exert a biasing force against the respective cable to secure the cable within assembly.

21. The cable clip assembly according to claim 15, wherein each securing mechanism comprises a latching member extending downwardly from the lower end of the respective support member.

22. (canceled)

23. The cable clip assembly according to claim 15, wherein an upper end of each support member comprises an opening, the openings configured to receive a respective securing mechanism of the second identical cable clip assembly.

24. The cable clip assembly according to claim 21, wherein an upper end of each support member further comprises a shoulder configured to engage with the latching member of a respective securing mechanism of the second identical cable clip assembly.

25. A base station antenna, the base station antenna comprising:
a phase shifter assembly comprising a mounting base having a main printed circuit board attached on a top side of the mounting base, the main printed circuit board having a top side with a plurality of transmission lines, the transmission lines connecting an input pad to an output pad, wherein a first cable is connected to the input pad and a second cable is connected to the output pad; and
a first cable clip assembly and a second cable clip assembly, each cable clip assembly secured to an opposing end of the mounting base and comprising:
a bridge member comprising a plurality of cable clip units extending upwardly therefrom, each cable clip unit configured to retain a respective cable therein;
a pair of support members, each support member coupled to or integral with an opposing end of the bridge member and extending downwardly therefrom; and
a securing mechanism coupled to a lower end of each support member, each securing mechanism configured to secure the cable clip assembly to a mounting base or a second identical cable clip assembly in a stacked relationship,
wherein the first cable is retained within a respective cable clip unit of the first cable clip assembly and wherein the second cable is retained with a respective cable clip unit of the second cable clip assembly.

26.-27. (canceled)
